(19) United States
(12) Patent Application Publication
(10) Pub. No.: US 2026/0074557 A1
(43) Pub. Date: Mar. 12, 2026

(54) POWER SUPPLY SYSTEM FOR VEHICLE

(71) Applicant: TOYOTA JIDOSHA KABUSHIKI KAISHA, Toyota-shi (JP)

(72) Inventor: Keita SAKURAI, Yaizu-shi (JP)

(73) Assignee: TOYOTA JIDOSHA KABUSHIKI KAISHA, Toyota-shi (JP)

(21) Appl. No.: 19/286,530

(22) Filed: Jul. 31, 2025

(30) Foreign Application Priority Data
Sep. 11, 2024 (JP) 2024-157682

(51) Int. Cl. H02J 13/00

(52) U.S. Cl. CPC H02J 13/1313; H02J 13/34; H02J 2105/30

(57) ABSTRACT

The first control device is connected to a power supply. The second control device is connected to the first control device via a power supply line and operates with power supplied from the first control device via the power supply line. The switch switches whether or not to make the power supply and the power supply line conductive to each other. The power supply unit is configured to supply power to a power supply line. When the switch is in the conduction state, power is supplied from the power supply to the power line at a first voltage. When the switch is in a non-conductive state, power is supplied from the power supply unit to the power supply line at a second voltage. The first controller switches a switch to transmit the pulse signal to the second control device via a power supply line.

### CROSS-REFERENCE TO RELATED APPLICATION

This application claims priority to Japanese Patent Application No. 2024-157682 filed on Sep. 11, 2024. The disclosure of the above-identified application, including the specification, drawings, and claims, is incorporated by reference herein in its entirety.

### BACKGROUND

### 1. Technical Field

The present disclosure relates to a power supply system for a vehicle.

### 2. Description of Related Art

Japanese Unexamined Patent Application Publication No. 2013-93655 (JP 2013-93655 A) discloses an in-vehicle communication system. The system includes a meter electronic control unit (ECU) that is disposed on an instrument panel and supplies a direct current power supply, a communication ECU that is disposed at a rear end portion of a vehicle, and a single transmission path that connects the meter ECU and the communication ECU. The meter ECU includes means for converting a direct current power supply voltage into a pulse-shaped sequence voltage according to a switch signal. The communication ECU includes means for monitoring the pulse-shaped sequence voltage.

### SUMMARY

In the technology of JP 2013-93655 A, the low level of the pulse-shaped sequence voltage is 0 V, and the high level of the pulse-shaped sequence voltage is 12 V. Therefore, while the pulse-shaped sequence voltage is 0 V, the power supply from the meter ECU to the communication ECU is disconnected. While the power supply to the communication ECU is disconnected, the communication ECU supplies the power from a capacitor to a load lamp. However, in a case where the capacity of the capacitor is insufficient, there is a possibility that the lighting of the lamp becomes unstable. In a case where the capacity of the capacitor is increased, the system is likely to be increased in size, and the product cost is also likely to be increased.

An object of the present disclosure is to provide a technique capable of more appropriately transmitting a signal via a power supply line that supplies power from a first control device to a second control device in a power supply system for a vehicle.

A power supply system for a vehicle according to a first aspect of the present disclosure includes
a first control device connected to a power supply, and
a second control device configured to operate with power supplied from the first control device via a power supply line, the second control device being connected to the first control device via the power supply line.
The first control device includes
a switch configured to switch between conducting and non-conducting between the power supply and the power supply line,
a first controller configured to control the switch, and
a power supply unit configured to supply the power to the power supply line.
In a case where the switch is in a conductive state, the power is supplied from the power supply to the power supply line at a first voltage.
In a case where the switch is in a non-conductive state, the power is supplied from the power supply unit to the power supply line at a second voltage different from the first voltage.
The first controller transmits a pulse signal to the second control device via the power supply line by switching the switch.
The second control device includes a second controller configured to determine a control content based on the pulse signal received via the power supply line.

According to the present disclosure, it is possible to provide the technique capable of more appropriately transmitting the signal via the power supply line that supplies the power from the first control device to the second control device in the power supply system for the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a power supply system of a vehicle according to an embodiment;

FIG. 2A is a diagram showing an example of a pulse signal;

FIG. 2B is a diagram showing an example of the pulse signal;

FIG. 3 is a diagram for describing a transition of an operation mode;

FIG. 4 is a flowchart showing an operation of the first control device of FIG. 1; and

FIG. 5 is a flowchart showing an operation of the second control device of FIG. 1.

### DETAILED DESCRIPTION OF EMBODIMENTS

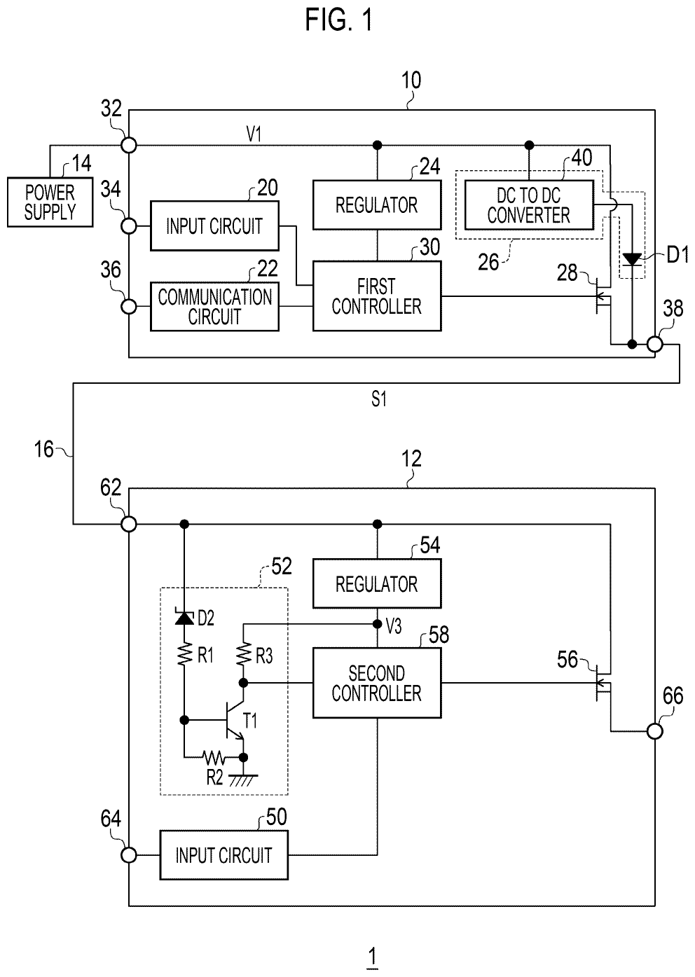

FIG. 1 schematically shows a configuration of a power supply system 1 of a vehicle according to an embodiment. The power supply system 1 is mounted on a vehicle (not shown) and supplies electric power to various electric loads. The vehicle may be a vehicle that uses solely an internal combustion engine as a traveling drive power source, or may be an electrified vehicle that uses an electric motor as a traveling drive power source. The electrified vehicle is, for example, a battery electric vehicle (BEV), a hybrid electric vehicle (HEV), a plug-in hybrid electric vehicle (PHEV), or a fuel cell electric vehicle (FCEV). The vehicle may be a vehicle driven by a driver or may be an autonomous driving vehicle.

As shown in FIG. 1, the power supply system 1 includes a first control device 10, a second control device 12, a power supply 14, and a power supply line 16. The first control device 10 and the second control device 12 can be configured by an electronic control unit (ECU), respectively.

The first control device 10 is connected to a direct current power supply 14 via a power supply terminal 32. The power supply 14 is, for example, an auxiliary battery of a vehicle. The voltage of the power supply 14 is a first voltage V1. The first voltage V1 is, for example, about 13.5 V.

The second control device 12 is connected to the first control device 10 via a power supply line 16 and operates with electric power supplied from the first control device 10 via the power supply line 16.

The second control device 12 can control whether or not to supply power to a load (not shown) of the vehicle connected to the output terminal 66. The load may include, for example, various lamps, such as a headlamp, a peripheral monitoring camera, and various ECUs. The load operates using the electric power supplied from the first control device 10 to the second control device 12.

The first control device 10 includes an input circuit 20, a communication circuit 22, a regulator 24, a power supply unit 26, a switch 28, and a first controller 30.

The input circuit 20 is connected to an ignition switch of a vehicle (not shown) or the like via the switch input terminal 34. The input circuit 20 can also be called a switch input interface circuit. The input circuit 20 receives an input of a signal indicating whether the ignition switch is on or off, and supplies the switch information indicating whether the ignition switch is on or off to the first controller 30.

The communication circuit 22 is connected to another ECU or microcomputer of the vehicle via a communication input terminal 36. The communication circuit 22 can also be called a communication interface circuit. The communication circuit 22 receives an input of the control signal from another ECU or microcomputer, and supplies control information specified from the control signal to the first controller 30.

The regulator 24 receives the first voltage V1 from the power supply 14 via the power supply terminal 32, adjusts the first voltage V1 to a predetermined power supply voltage, and supplies the adjusted power supply voltage to the first controller 30.

The power supply unit 26 receives power from the power supply 14 via the power supply terminal 32, and can supply power to the power supply line 16 via the output terminal 38 based on the received power. The power supply unit 26 can also be called an always-on power supply.

The power supply unit 26 includes a DC-DC converter 40 and a diode D1. The DC-DC converter 40 steps down the first voltage V1 supplied from the power supply 14.

The diode D1 has an anode to which a voltage stepped down by the DC-DC converter 40 is supplied, and a cathode connected to one end of the power supply line 16 via the output terminal 38. The cathode of the diode D1 outputs the second voltage V2 when the switch 28 is in a non-conductive state. The second voltage V2 is lower than the first voltage V1, and is, for example, 10 V. The second voltage V2 is set in advance to a voltage at which the second control device 12 and the load can be operated.

The switch 28 switches whether or not to make the power supply 14 and the power supply line 16 conductive to each other. The switch 28 is, for example, a semiconductor relay or a semiconductor switch. The switch 28 includes one end to which the first voltage V1 is supplied from the power supply 14 via the power supply terminal 32, the other end connected to one end of the power supply line 16 via the output terminal 38, and a control terminal to which a control signal is supplied from the first controller 30. That is, the cathode of the diode D1 and the other end of the switch 28 are commonly connected to the output terminal 38.

When the switch 28 is in the conduction state, electric power is supplied from the power supply 14 to the power supply line 16 at a first voltage V1 through the switch 28. When the switch 28 is in the conduction state, the electric power is not supplied from the power supply unit 26 to the power supply line 16. On the other hand, in a case where the switch 28 is in a non-conductive state, the electric power is supplied from the power supply unit 26 to the power supply line 16 at the second voltage V2.

Therefore, the voltage of the power supply line 16 changes to the first voltage V1 or the second voltage V2 according to whether or not the switch 28 is in the conduction state. The first control device 10 can supply the second control device 12 with the electric power with which the second control device 12 and the load can be operated, regardless of whether or not the switch 28 is in the conduction state.

The first controller 30 controls the switch 28. The first controller 30 generates the pulse signal S1 by switching the switch 28 to the conduction state and the non-conduction state in a predetermined case, and transmits the generated pulse signal S1 to the second control device 12 via the power supply line 16. A high level of the pulse signal S1 is a first voltage V1, and a low level of the pulse signal S1 is a second voltage V2. The pulse signal S1 is, for example, a pulse width modulation (PWM) signal. The first controller 30 can be said to superimpose the pulse signal S1 on the power supply line 16. The first controller 30 can be configured by, for example, a microcomputer.

The first controller 30 determines whether or not a change condition of a predetermined operation mode is satisfied based on the switch information supplied from the input circuit 20 and the control information supplied from the communication circuit 22.

The operation mode includes, for example, a first mode, a second mode, and a third mode. The first mode is an operation mode when the ignition switch is off. The first mode is a low power consumption mode selected while the vehicle is parked. In the first mode, the power supply state of the vehicle is a power supply off state.

The second mode is an operation mode when the ignition switch is on. The second mode is a mode in which normal control selected during traveling of the vehicle is executed. In the second mode, the power supply state of the vehicle is the IG on state.

The third mode is a mode when the ignition switch is off and the intermittent operation is instructed. The third mode is selected while the vehicle is parked. The third mode is a low power consumption mode, but is a mode in which the load is operated periodically.

Details of each mode will be described below. A larger number of modes may be provided as the operation mode.

The fact that the change condition of the operation mode is satisfied corresponds to, for example, the fact that the ignition switch is turned on from off or the fact that the ignition switch is turned off from on. Alternatively, the fact that the change condition of the operation mode is satisfied corresponds to the fact that the intermittent operation is instructed by the control information when the ignition switch is off.

When the change condition of the operation mode is not satisfied, the first controller 30 keeps the switch 28 in the conduction state. In this case, the pulse signal S1 is not transmitted, and the normal power supply to the second control device 12 continues.

When the change condition of the operation mode is satisfied, the first controller 30 transmits the pulse signal S1 of the duty ratio associated with the changed operation mode over a predetermined transmission period, and then controls the switch 28 to the conduction state. The frequency and the transmission period of the pulse signal S1 can be appropriately determined by an experiment or a simulation. For example, the pulse signal S1 may include several pulses to about 10 pulses during the transmission period.

The frequency of the pulse signal S1 may be, for example, several kHz. A low-pass filter may be provided between the other end of the switch 28 and the connection node of the cathode of the diode D1 and the output terminal 38. As a result, the S/N ratio of the pulse signal S1 can be improved.

For example, a 0% duty ratio is associated with the first mode. A 100% duty ratio is associated with the second mode. A 50% duty ratio is associated with the third mode. The duty ratios of the respective modes may be, for example, different by 10% each.

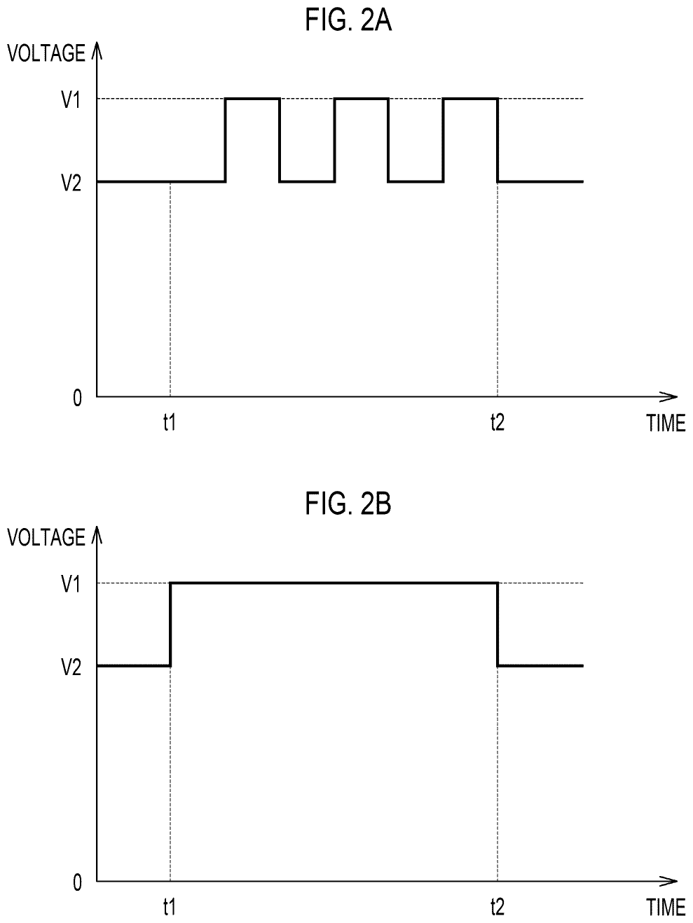

FIGS. 2A and 2B show an example of the pulse signal S1 of FIG. 1. FIG. 2A shows a pulse signal S1 having a duty ratio of 50%. FIG. 2B shows a pulse signal S1 having a duty ratio of 100%. In this example, the duty ratio is the on-duty ratio. The period from time t1 to time t2 is a transmission period.

As shown in FIG. 2A, during the period in which the switch is in the non-conductive state in the transmission period, the second voltage V2 is supplied from the power supply unit 26 to the power supply line 16, and thus the second control device 12 and the load can stably operate even in the transmission period.

Back to FIG. 1. The second control device 12 includes an input circuit 50, a detector 52, a regulator 54, a switch 56, and a second controller 58.

The input circuit 50 is connected to a switch (not shown) that can be operated by the user via the switch input terminal 64. The switch is provided in a vehicle cabin and is for controlling the operation of the load. The input circuit 50 can also be called a switch input interface circuit. The input circuit 50 receives, for example, an input of a signal indicating whether the switch is on or off, and supplies the switch information indicating whether the switch is on or off to the second controller 58.

The detector 52 detects the pulse signal S1 received via the power supply line 16 and the power supply terminal 62, and supplies a signal indicating a detection result to the second controller 58. The detector 52 includes a Zener diode D2, a first resistor R1, a second resistor R2, a transistor T1, and a third resistor R3.

The Zener diode D2 has a cathode connected to the other end of the power supply line 16 via the power supply terminal 62 and an anode.

The first resistor R1 and the second resistor R2 are connected in series between the anode of the Zener diode D2 and the ground.

The transistor T1 has a control terminal connected to a connection node of the first resistor R1 and the second resistor R2, a first terminal grounded, and a second terminal that outputs a signal indicating a detection result to the second controller 58.

The third resistor R3 has one end to which the third voltage V3 is supplied and the other end connected to the second terminal of the transistor T1.

When the pulse signal S1 is at a low level, that is, when the second voltage V2 is supplied to the power supply terminal 62, the transistor T1 is in a non-conductive state, and the transistor T1 outputs the third voltage V3 as a signal indicating the detection result.

On the other hand, in a case where the pulse signal S1 is at a high level, that is, in a case where the first voltage V1 is supplied to the power supply terminal 62, the transistor T1 is in a conductive state, and the transistor T1 outputs a voltage lower than the third voltage V3 as a signal indicating the detection result.

With the detector 52 having such a circuit configuration, the pulse signal S1 superimposed on the power supply line 16 can be detected.

The regulator 54 adjusts the first voltage V1 or the second voltage V2 of the power supply line 16 to a predetermined third voltage V3. The third voltage V3 is lower than the second voltage V2.

The switch 56 switches whether or not to electrically connect the power supply terminal 62 and the output terminal 66. The switch 56 is, for example, a semiconductor relay or a semiconductor switch. The switch 56 includes one end to which the first voltage V1 or the second voltage V2 is supplied through the power supply terminal 62, the other end connected to the output terminal 66, and a control terminal to which a control signal is supplied from the second controller 58.

When the switch 56 is in the conduction state, the electric power supplied from the power supply line 16 is supplied to the load via the switch 56. When the switch 56 is in a non-conductive state, the power supply to the load is disconnected.

The second controller 58 operates using the third voltage V3 as a power supply voltage, and decides the control content based on the pulse signal S1 received via the power supply line 16. The second controller 58 executes control according to a detection result of the detector 52. The second controller 58 specifies the duty ratio of the pulse signal S1 from the detection result of the detector 52, specifies the operation mode from the specified duty ratio, and executes the control according to the specified operation mode. The second controller 58 can be configured by, for example, a microcomputer.

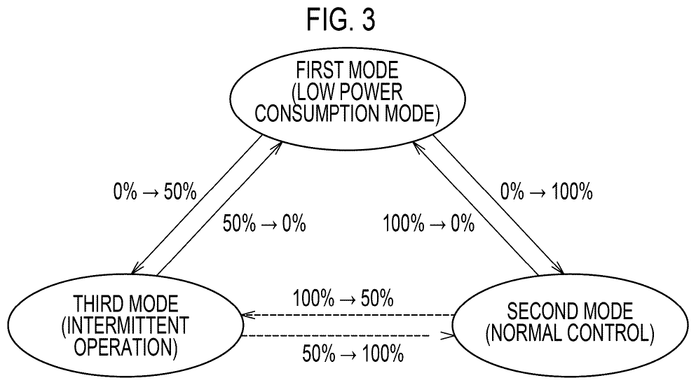

FIG. 3 is a diagram for describing a transition of an operation mode. In the first mode, the first controller 30 monitors the switch information of the input circuit 20 serving as a trigger or the control information of the communication circuit 22, and the second controller 58 monitors the signal indicating the detection result by the detector 52.

In the second mode, the load can be operated, and the function of the load can be fully exhibited. In the second mode, the second controller 58 monitors the switch information of the input circuit 50, controls the switch 56 to be in the conduction state or the non-conduction state in accordance with the switch information, and controls the operation of the load.

In the third mode, the second controller 58 intermittently supplies the power to the load by intermittently switching the switch 56 from the non-conductive state to the conductive state, and intermittently operates the load. For example, the second controller 58 periodically operates the peripheral monitoring camera, which is a load.

As indicated by the solid line arrow in FIG. 3, the mode can be transitioned from the first mode to the second mode, and can be transitioned from the second mode to the first mode. In addition, the mode can be transitioned from the first mode to the third mode, and can be transitioned from the third mode to the first mode.

When the operation is changed from the first mode to the second mode, the pulse signal S1 having a duty ratio of 100% is supplied to the second control device 12 when the first voltage V1 is supplied to the second control device 12. The operation mode may be changed from the first mode to the second mode while the detector 52 is operated to detect the pulse signal S1 having a 100% duty ratio. In such a case, the first controller 30 may transmit the pulse signal S1 after transmitting the second voltage V2 for a predetermined time shorter than the transmission period. The detector 52 can detect the pulse signal S1 having a 100% duty ratio over the transmission period after detecting the second voltage V2 for a predetermined time. That is, the detector 52 can detect the start point of the pulse signal S1.

When the load connected to the output terminal 66 of the second control device 12 is a load that flows a constant current to the LED or the like in the constant current circuit, the transition may be directly made between the second mode and the third mode as indicated by a broken line arrow in FIG. 3. This is because, even when the voltage supplied to the switch 56 via the power supply terminal 62 during the transmission of the pulse signal S1 fluctuates between the first voltage V1 and the second voltage V2 and the voltage supplied from the output terminal 66 to the load also fluctuates in the same manner, the fluctuation does not substantially affect the operation of the load.

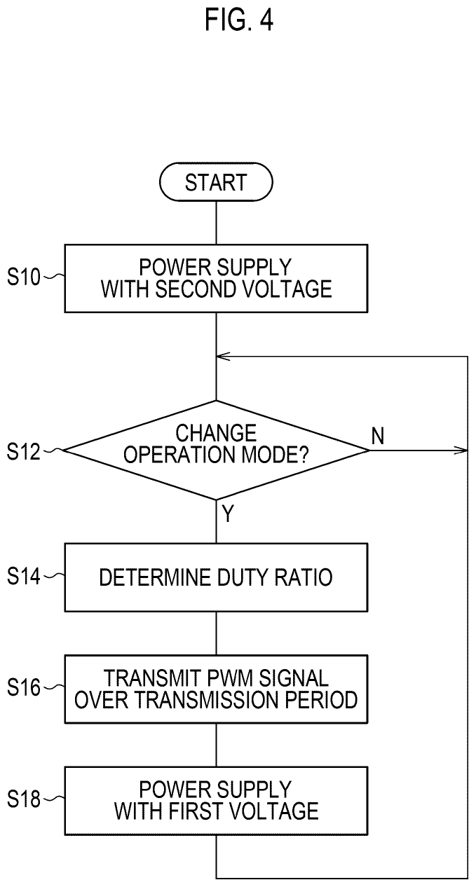

FIG. 4 is a flowchart showing an operation of the first control device 10 of FIG. 1. The process of FIG. 4 is started, for example, when the power supply 14 is connected to the power supply terminal 32 of the first control device 10 in a vehicle manufacturing plant, a vehicle maintenance plant, or the like, and the supply of electric power from the power supply 14 to the first control device 10 is started.

The first controller 30 controls the switch 28 to be in a non-conductive state to supply the second voltage V2 (S10). The first controller 30 determines whether or not to change the operation mode (S12). When the operation mode is not changed (N in S12), the process returns to S12. When the operation mode is changed (Y in S12), the first controller 30 decides the duty ratio according to the changed operation mode (S14), and transmits the PWM signal over the transmission period (S16). The first controller 30 controls the switch 28 to be in a conductive state, supplies the power at the first voltage V1 (S18), and the process returns to S12.

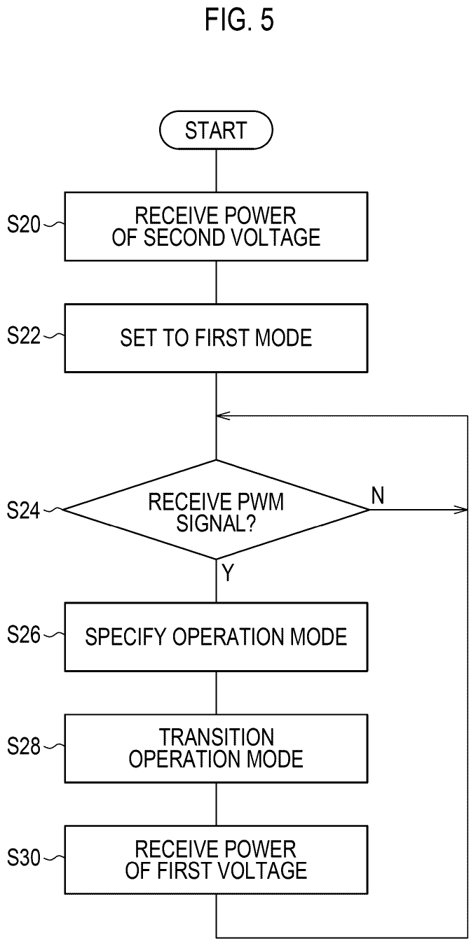

FIG. 5 is a flowchart showing an operation of the second control device 12 of FIG. 1. The process of FIG. 5 is started when the process of FIG. 4 is started, and is executed in parallel with the process of FIG. 4.

The second control device 12 receives the second voltage V2 supplied in S10 of FIG. 4 (S20). The second controller 58 sets the operation mode to the first mode (S22), and determines whether or not the PWM signal is received (S24). When the PWM signal is not received (N in S24), the process returns to S24. When the PWM signal is received (Y in S24), the second controller 58 specifies the operation mode based on the PWM signal (S26), and the operation mode is transitioned (S28). The second control device 12 receives the first voltage V1 supplied in S18 of FIG. 4 (S30), and the process returns to S24.

In S10 of FIG. 4, the first controller 30 may supply power at the first voltage V1. In this case, in S20 of FIG. 5, the second control device 12 receives the first voltage V1.

According to the embodiment, the pulse signal S1 can be transmitted from the first control device 10 to the second control device 12 through the same power supply line 16 without interrupting the power supply from the first control device 10 to the second control device 12 through the power supply line 16. Therefore, the pulse signal S1 can be more appropriately transmitted through the power supply line 16.

In addition, a dedicated electric wire for transmitting the pulse signal S1 can be reduced. Further, the power supply system 1 can be realized with a simple circuit configuration without needing a dedicated communication IC. Therefore, the cost of the power supply system 1 can also be reduced.

The disclosure has been described above based on the embodiments. It should be noted that the embodiments are merely an example, and it is understood by those skilled in the art that various modification examples can be made to the combination of the components and processes thereof, and that such modification examples are also within the scope of the disclosure.

For example, the pulse signal S1 may be a signal in which a pulse width is fixed. In this case, for example, the high level of the pulse signal S1 may represent “1” or the low level of the pulse signal S1 may represent “0”, and the pulse signal S1 may represent a digital signal. According to the modification example, the degree of freedom of the configuration of the power supply system 1 can be improved.

What is claimed is:

1. A power supply system for a vehicle, the power supply system comprising:
a first control device connected to a power supply; and
a second control device configured to operate with power supplied from the first control device via a power supply line, the second control device being connected to the first control device via the power supply line, wherein:
the first control device includes
a switch configured to switch between conducting and non-conducting between the power supply and the power supply line,
a first controller configured to control the switch, and
a power supply unit configured to supply the power to the power supply line;
in a case where the switch is in a conductive state, the power is supplied from the power supply to the power supply line at a first voltage;
in a case where the switch is in a non-conductive state, the power is supplied from the power supply unit to the power supply line at a second voltage different from the first voltage;
the first controller transmits a pulse signal to the second control device via the power supply line by switching the switch; and
the second control device includes a second controller configured to determine a control content based on the pulse signal received via the power supply line.

2. The power supply system according to claim 1, wherein the pulse signal is a PWM signal.

3. The power supply system according to claim 2, wherein:
the second controller executes control according to an operation mode; and
in a case where a change condition of the operation mode is satisfied, the first controller controls the switch to the conductive state after transmitting the pulse signal having a duty ratio previously associated with a changed operation mode over a transmission period.

4. The power supply system according to claim 1, wherein the power supply unit includes
a direct current (DC)-DC converter configured to step down the first voltage supplied from the power supply, and
a diode including an anode to which a voltage stepped down by the DC-DC converter is supplied, and a cathode connected to the power supply line to output the second voltage.

5. The power supply system according to claim 1, wherein:
the second control device includes
a detector configured to detect the pulse signal received via the power supply line, and
a regulator configured to adjust a voltage of the power supply line to a third voltage;
the second controller operates using the third voltage as a power supply voltage and executes control according to a detection result by the detector; and
the detector includes
a Zener diode including a cathode connected to the power supply line,
a first resistor and a second resistor connected in series between an anode of the Zener diode and ground,
a transistor including a control terminal connected to a connection node of the first resistor and the second resistor, a first terminal that is grounded, and a second terminal configured to output a signal indicating the detection result to the controller, and
a third resistor including a first end to which the third voltage is supplied and a second end connected to the second terminal.
